(19) United States
(12) Patent Application Publication
(10) Pub. No.: US 2026/0208743 A1
(43) Pub. Date: Jul. 23, 2026

(54) METHOD FOR PRODUCING AN EVALUATION MODEL FOR DETECTING A SEAT OCCUPANCY STATE OF A SEAT ARRANGEMENT

(71) Applicant: Gestigon GmbH, Luebeck (DE)

(72) Inventors: Joel Ewig, Luebeck (DE); Lena Werner, Luebeck (DE)

(73) Assignee: Gestigon GmbH, Luebeck (DE)

(21) Appl. No.: 19/136,766

(22) PCT Filed: Dec. 6, 2023
(86) PCT No.: PCT/EP2023/084504

§ 371 Date: Jun. 6, 2025

(30) Foreign Application Priority Data
Dec. 9, 2022 (DE) 10 2022 132 747.7

(51) Int. Cl. B60W 40/08; B60R 22/48; G06N 20/00

(52) U.S. Cl. CPC B60W 40/08; B60R 22/48; G06N 20/00; B60R 2022/4808; B60W 2040/0881; B60W 2420/408

(57) ABSTRACT

Described is a method for producing a machine learning model for automated detection of a seat occupancy state of a seat arrangement. Parameters are assigned to possible seat occupancy states, and hyperparameters are configured to be adjusted on the basis of a metric. A detection accuracy is determined indicating a discrepancy between the seat occupancy state assigned to the parameters and an evaluation result supplied by the evaluation model with the provided hyperparameters. A metric is evaluated which takes into account a difference between the detection accuracy and a target value to output a value for the determined detection accuracy. Hyperparameters are adjusted appropriately, where the metric is optimized in order to obtain an optimum from the output value and to adjust the hyperparameters in such a way for which the metric reaches the optimum. The evaluation model is produced with the adjusted hyperparameters for further training.

The present invention relates to a method for producing an evaluation model, in particular a machine learning model, for use in a method for detecting a seat occupancy state of a seat arrangement having at least one seat. The invention also relates to a method for training the evaluation model and a method, a computer program and a system configured to carry out the method, each for detecting a seat occupancy state by using such a trained evaluation model.

In various situations, it may be necessary to automatically determine the current seat occupancy state of a seating arrangement having at least one seat. Such a situation may occur in particular in vehicles, for example in motor vehicles, where a configuration of the vehicle or an activation, deactivation and/or control of one or more vehicle functionalities is to be carried out depending on a current seat occupancy state. For example, in motor vehicles it is known to output an acoustic or visual cue to vehicle occupants to put on seat belts or to control the activation and deactivation of airbags, depending on a detected seat occupancy state.

For the automated detection of a current seat occupancy state, in particular of an arrangement of vehicle seats in a vehicle, methods in which the interior of a vehicle is monitored are known. In particular, methods are known which use radar technology for the automated detection of a current seat occupancy state. By means of radar scanning of the vehicle interior by radar sensors, measured data in the form of radar point clouds are generated. By using the measured radar point cloud, conclusions about current seat occupancy can be drawn.

To evaluate the radar point clouds, a corresponding evaluation model is used, which may be a machine learning (ML) model, wherein the known methods may be capable also of detecting the type of seat occupancy by means of the machine learning model, for example whether a seat is occupied by an adult or a child. Also known are methods which are capable of performing a still more differentiated evaluation of the seat occupancy state, in particular with regard to body size and weight of an adult or the age of a child. For example, it may be necessary to distinguish between a six-year old child and a four-year old child in order to be able to take the different body sizes of the children into account.

During the production of the ML model, hyperparameters of the model are produced with the aid of optimization methods. For this purpose, a metric for a detection accuracy of an evaluation result can be used for known parameters which are based on the discrepancy between the correct result (e.g. the actual seat occupancy state) as a result of the evaluation model. In the case of unweighted datasets, i.e. datasets in which, for example, one class is over-represented and another is under-represented, the choice of a metric can lead to evaluation results for the over-represented class, which may in any case be of very good quality, being still further improved since these on average compensate for poorer evaluation results (of the under-represented class), which are then not further improved in the reverse conclusion. Within the context of a belt warning system, it is therefore possible that the detection of average adults, which is good in any case, is improved further and further, whereas a possibly inadequate detection of children is not improved.

It is an object of the present invention to provide an improved solution for the automated detection of a seat occupancy state of a seating arrangement having at least one seat. In particular, an improved solution for producing an evaluation model and for the automated detection of a seat occupancy state of a seat arrangement is to be specified which offers a more well balanced detection accuracy over different classes.

The object is achieved according to the teaching of the independent claims. Various embodiments and developments of the invention are the subject matter of the dependent claims.

A first aspect of the solution presented here relates to an in particular computer-implemented method for producing an evaluation model for the automated detection of a seat occupancy state of a seat arrangement having at least one seat. In the method, parameters which are assigned to at least one of a plurality of specified possible seat occupancy states of the seat arrangement, and also hyperparameters for the evaluation model, are provided, wherein the hyperparameters are configured to be adjusted on the basis of a metric. A detection accuracy is determined, wherein the detection accuracy indicates a discrepancy between the seat occupancy state assigned to the parameters and an evaluation result supplied by the evaluation model with the hyperparameters provided. A metric is provided and evaluated, wherein the metric takes into account the difference between the detection accuracy and a specified target value in order to specify a value for the determined detection accuracy, wherein the target value indicates a detection accuracy at which the metric reaches an optimum. The hyperparameters of the evaluation model are then appropriately adjusted, wherein the metric is optimized by means of an optimization method for this purpose. The evaluation model is produced with the adjusted hyperparameters for further use for training with training data for a method for the automated detection of a seat occupancy state of a seat arrangement having at least one seat.

With the aid of the method according to the first aspect, it is possible to produce an evaluation model, in particular a machine learning model, with which a more balanced detection accuracy can be achieved for different seat occupancy states. By using a specified target value, it is possible in particular for a further improvement in a detection accuracy beyond the target value to be braked, while detection accuracies for regions below the target value are further improved. In other words, an improvement beyond the target value is punished by the metric, whereas known metrics usually operate without such a target value in order to optimize a detection accuracy up to a maximum.

The method is advantageous in particular for the machine learning of a radar-assisted system for detecting seat occupancy. In particular the detection of specific seat occupancy states which are detected more poorly by comparison when conventional metrics and optimization methods are used, can be improved. The detection of specific seat occupancy states which are detected better by comparison when conventional metrics and optimization methods are used can be made slightly poorer. However, since these can be detected with sufficient reliability and the detection remains above a value which is also viewed as adequate, no disadvantage arises as a result in practice. Instead, a detection accuracy that is more uniform and is sufficient for a higher number of different seat occupancy states can be achieved.

The term “seat occupancy state” of a seat arrangement having at least one seat, as used herein, is in particular to be understood as information which indicates whether or to what extent the seat arrangement or at least one of the seats is occupied by an object, in particular a thing or a person. The seat occupancy state in a simple example may only indicate the presence or absence of an object, or in a further developed example, in the case of the presence of at least one object on the seating arrangement or one or more of its seats, make a statement about the nature or another characteristic of the object, for example, its spatial extent.

The term “evaluation model”, as used herein, is to be understood to mean an in particular mathematical model which a radar point cloud, or one or more parameters characteristic thereof, uses as input variable(s) to return an evaluation result dependent on it, in the present case one of multiple specified possible seat occupancy states of the seating arrangement. In particular, the evaluation model may be a mathematical estimation function, wherein the radar point cloud represents empirical data as a random sample and the evaluation result represents an estimation determined as a function thereof. The evaluation model may in particular be a “machine learning model”, which is understood here in particular to mean a mathematical, in particular statistical, model for making predictions or decisions by means of at least one machine learning algorithm on the basis of example data, known as training data, without the algorithm(s) being explicitly programmed to make such predictions or decisions. In particular, decision tree-based models (“decision trees”) are machine learning models for machine learning.

The term “metric”, as used herein, is to be understood in particular to mean a mathematical depiction which assigns a numerical value to one or more detection accuracies. The metric is used in particular for hyperparameter optimization, in that its value is supplied to an optimization method in order then to adjust the hyperparameters accordingly. In particular weights in the evaluation model can be adjusted appropriately in order to achieve a specific behavior of the evaluation model.

The term “parameter”, as used herein, is to be understood in particular as a value relating to the seat occupancy state as can also occur in the actual operation of the evaluation model during a method for detecting a seat occupancy state. The parameters can in particular indicate whether a seat is occupied or not, how a seat is possibly occupied (e.g. adult or child) and, if appropriate, further circumstances, such as the state of the vehicle (e.g. whether it is travelling or stationary).

The term “hyperparameter”, as used herein, is to be understood in particular—as opposed to the previously explained parameters—to be a parameter of the evaluation model which is determined during the production of the evaluation model in order to control the model during training. The hyperparameters are thus determined and fixed before the actual training of the model.

The term “radar point cloud”, as used herein, is to be understood in particular to mean a set of points of a vector space obtained by means of radar scanning of at least one object surface, which has a typically unorganized spatial structure (“cloud”). In the case of a radar point cloud, the points of the radar point cloud can be designated as “radar points”. A (radar) point cloud can be described in particular by the (radar) points contained in it. The radar points, in turn, can each be described in particular by their spatial coordinates, each of these radar points specifying a location of reflection of a radiated radar signal at an object surface measured in the radar scanning. In addition to the radar points, attributes such as measured Doppler velocity or a signal-to-noise ratio (SNR) can be acquired.

The terms “comprises”, “contains”, “includes”, “has”, “with” or any other variant thereof are intended to cover a non-exclusive inclusion. By way of example, a method or a device that comprises or has a list of elements is thus not necessarily limited to those elements, but may include other elements that are not expressly listed or that are inherent in such a method or such a device.

Furthermore, if the opposite is not expressly specified, “or” relates to an inclusive or and not to an exclusive “or”. For example, a condition A or B is satisfied by one of the following conditions: A is true (or present) and B is false (or absent), A is false (or absent) and B is true (or present), and both A and B are true (or present).

The terms “a” or “one”, as used here, are defined in the sense of “one/one or more”. The terms “another” and “a further” and any other variant thereof are to be understood in the sense of “at least one further”.

The term “a plurality” or “plurality”, as used here, is to be understood in the sense of “two or more”.

The terms “configured” or “set up” to fulfil a specific function (and respective modifications thereof) are to be understood in the sense of the invention to mean that the corresponding device is already present in a configuration or setting in which it can carry out the function or it can be adjusted—i.e. configured—at least such that it can carry out the function after appropriate adjustment. The configuration can be applied, for example, by an appropriate setting of parameters of a process sequence or of switches or similar for activating or deactivating functionalities or settings. In particular, the device may comprise multiple predetermined configurations or operating modes, so that the configuration can be carried out by means of a selection of one of these configurations or operating modes.

Various exemplary embodiments of the method will now be described below, each of which, unless expressly excluded or technically impossible, may be combined as desired with one another and with the other aspects of the present solution also described.

In some embodiments, the target value is smaller than the maximum detection accuracy, so that the value of the metric for the target value is at a maximum. In this way, preference is given to hyperparameters in which a detection accuracy is not maximised at any cost (which, as explained above, can lead to an imbalance between results which are strong in any case and weak results). In particular, the detection accuracy can be determined with a value in the interval [0; 1] and the target value fixed to a value of less than 1. The metric reaches a maximum value at values less than 1, e.g. 0.9 or 0.95. Evaluation results which exhibit a discrepancy from the target value are punished, therefore not as usual, not only low values (i.e. values with a large discrepancy relative to the “optimal” value 1) but also values greater than the target value.

In some embodiments, the provision of the parameters comprises providing a set of parameters which are assigned to a plurality of seat occupancy states, and the detection accuracy is in each case determined from combinations of parameters from the set of parameters, wherein the metric is defined as an average which is formed for the set of parameters and the respective detection accuracy. The average can be, for example, the geometric mean. A set of parameters can, for example, contain combinations of parameters in which a value is specified, e.g. a specific seat of the seat arrangement or whether the engine is running or not. A combination of driver size, seat and vehicle state can be, for example: a small woman (AF05) is sitting on the driver's seat with the vehicle stationary. The detection accuracy can then be determined (calculated) for all possible combinations of the selected parameters. Then, in turn, in each case the difference from the target value can be calculated for each calculated detection accuracy.

In some embodiments, the metric contains the natural exponential function, which comprises the magnitude of a difference between the detection accuracy and the target value as an argument. A metric can appear as follows (including normalization, in order to obtain a value between 0 and 1 (“normalized”):

$$\\ raw = \sqrt[n]{{\prod }_{i = 0}^{n} {e}^{\vert {accuracy}_{i} - target \vert}} \\ normalized = \frac{raw - 1}{e - 1}$$

where n is the number of combinations of the selected parameters (e.g. n=3: child in a moving vehicle, no child in the moving auto, child in the stationary auto, no child in the stationary auto). Here, “accuracy” is the detection accuracy and “target” is the target value.

In some embodiments, the optimization method is a Bayesian optimization. In particular, the aforementioned normalized value of the metric is minimized by means of the Bayesian optimization.

In some embodiments, the optimization method is carried out with a specified number of iterations. While, for example, the Bayesian optimization theoretically permits an arbitrary number of iterations, it may be advantageous to limit the number of iterations and, after this number, to set the hyperparameters in such a way that they form the most promising hyperparameters for the evaluation model.

In some embodiments, the seat arrangement has a plurality of seats, wherein the seat occupancy state is an individual or cumulative seat occupancy state of the seats. In other words, a seat occupancy state can comprise one or more seats of the vehicle and their respective occupancy (in this regard, see also the explanations relating to cluster formations of a radar point cloud further below).

In some embodiments, the seat occupancy state comprises at least one type of seat occupancy for at least one seat of the seat arrangement. In particular, the determination of the seat occupancy state can comprise determining a type of seat occupancy. The type of seat occupancy can comprise at least one from a not occupied (i.e. free) seat, a seat occupied by an adult, a seat occupied by a child, a seat occupied by a child seat with an infant and a seat occupied by a baby carrier with a baby. In addition, provision can be made to detect whether a seat is occupied, for example, by an object or a doll. A person can be simulated, for example, by using the established THUMS human model. For example, the values AM95, AM50 and AF05 represent different adults (large/heavy man, mid-sized/medium-weight man and small/lightweight woman). Children can be characterized by using their age, for example 4YO or 6YO for a four-year old and a six-year old child.

Since it is not only determined whether a seat is occupied but also how, and the corresponding information is issued, differentiated control can be carried out, for example a belt warning system or airbag system. For example, specific airbags can be activated only when an adult assumes a seat, while an airbag can (or must) be deactivated when, although a seat is occupied, it is not by an adult but, for example, by a baby carrier which is placed counter to the direction of travel. When a child seat or a baby carrier is used, which is normally not secured with a seatbelt but, for example, by means of a specific fastening (“Isofix”), it is additionally advantageous if a seatbelt warning is not output, so that unnecessary warning messages can be avoided, which are not helpful and a user can perceive as disturbing.

In some embodiments, the parameters further comprise a state of the vehicle. The state of the vehicle can in particular comprise whether the vehicle is stationary or travelling and/or whether the engine is running or not. Taking the vehicle state into account can have a positive effect on the evaluation model, since this can have an influence on the result of the radar measurement, since different levels of shaking of the vehicle can influence the result of the radar monitoring of the vehicle interior.

A second aspect of the solution presented here relates to an in particular computer-implemented method for training an evaluation model produced in accordance with a method according to a first aspect for the automated detection of a seat occupancy state of a seat arrangement having at least one seat. In the method, measured data is required which represents an associated radar point cloud, wherein the radar point cloud is or has been obtained on the basis of radar scanning of at least sections of the spatial region encompassing the seat arrangement, and is assigned to one of a plurality of specified possible seat occupancy states of the seat arrangement. Training data is then produced from the measured data, wherein the training data is made available to the evaluation model as input data in order, as the output of the latter, to obtain an evaluation result which is assigned to the seat occupancy state of the seat arrangement.

The third aspect of the solution presented here relates to an in particular computer-implemented method for the automated detection of and in particular seat-based seat occupancy state of a seat arrangement having at least one seat (or, synonymously: seat), in particular a seat in or for a vehicle, such as an automobile (e.g. truck, passenger car or bus). The method comprises: (i) acquiring, in particular receiving or generating, measured data which represents an associated radar point cloud. Each radar point cloud is or has been obtained on the basis of radar scanning of at least sections of a spatial region encompassing the seat arrangement; (ii) determining, in particular estimating, a seat occupancy state of the seat arrangement by using an evaluation model which, as a function of the radar point cloud, supplies one of a plurality of specified possible seat occupancy states of the seat arrangement as an evaluation result, and (iii) issuing information defined on the basis of the evaluation result. The method according to the third aspect uses an evaluation model, in particular a machine learning model, which has been trained with the aid of the method according to the second aspect.

By using the method according to the third aspect, an evaluation result characterizing a seat occupancy state of the seat arrangement (in particular in the sense of a prediction or classification) can be obtained on the basis of a radar point cloud which has been obtained by means of radar scanning of a spatial region encompassing the seat arrangement. Thus, radar-based solutions can be implemented, in particular in the vehicle context (in particular for automobiles), which can reliably detect a seat occupancy state (in particular exclusively) by means of radar and, on this basis, can activate, deactivate or control certain functionalities or systems, such as a seatbelt warning system or an airbag system, either altogether or selectively.

In particular, the information to be output can represent the evaluation result itself. It may also be a signal, in particular detectable with a human sense, such as a warning, or a control signal for activating a signal source, or a data signal carrying the information.

Various exemplary embodiments of the method according to the third aspect will be described below, each of which, if this is not expressly excluded or technically impossible, can be combined with one another as desired and with the further described other aspects of the present solution.

In some embodiments, the seat arrangement has a plurality of seats, for which, individually or cumulatively, a seat occupancy state is to be determined within the context of the method. For each (individual) radar point cloud, the set of its radar points is divided by means of clustering into a plurality of clusters each containing a subset of the radar points, depending on the respective spatial position of the radar points in relation to the seats, in order to individually assign to each of the seats one of the clusters that is located closest to it. The determination of the seat occupancy state of the seat arrangement is carried out for each of the seats as a function of the radar point cloud determined for the respectively associated cluster, in order to obtain an evaluation result characterizing the seat occupancy state of the respective seat, in particular a classification result. The information to be output is then defined according to the respective individual evaluation results for the different seats.

In some associated embodiments, each radar point cloud is segmented into a plurality of clusters, in that each of the seats is assigned a subset of the radar points of the respective radar point cloud as a cluster, depending on the respective position, so that the radar points of the cluster are located in a defined closed spatial region, in particular a cuboid, in the surroundings of the seat. This enables particularly simple and less computationally intensive clustering and thus seat-related seat occupancy detection, wherein the location (position and orientation) and the shape of the spatial region is or can be defined in such a way that it usually strongly overlaps the spatial region generally occupied by a typical object to be detected, in particular a person, on a seat of the seating arrangement.

Thus, in the case of a multi-seat seat arrangement, seat-based, i.e. individual to each seat, seat occupancy detection is enabled which, in particular, is then advantageous or even necessary if there is to be a seat-based reaction to the detected seat occupancy depending on its detected seat occupancy, for example a specific functionality or a specific system, such as a seat-based airbag system, a seat-based seatbelt warning or seat-based seat heating is to be activated or deactivated or controlled in another way. In some embodiments, the clustering can be carried out in particular such that the clusters are disjoint, so that no radar point is assigned to two different clusters.

In some embodiments, the or each individual radar point cloud is segmented into a plurality of clusters, by each of the seats being assigned a subset of the radar points as a cluster as a function of the respective position in such a way, in particular uniquely for each radar point, that the radar points of the cluster are located in a defined closed, in particular cuboid, spatial region in the surroundings of the seat. In particular, the assignment can be carried out in such a way that each radar point is assigned to the cluster of the seat located nearest to it. Thus, the radar point cloud can be divided into clusters, i.e. subsets of the radar point cloud localized in the vicinity of the respective seats, so that the seat-specific seat occupancy states can be determined in a targeted manner and therefore with high reliability on the basis of the cluster assigned to the respective seat.

In some embodiments, the output of the information comprises activating a signal source as a function of the information to cause the signal source to output a defined signal depending on the activation. The signal source may in particular be an audio source, an optical signal source, in particular a display device for images or text, and/or a haptic actuator or a combination of at least two of the aforementioned signal sources. This means that by means of the signalling, the detected seat occupancy state can be communicated to a user or used to control another technical system, such as an airbag system.

In some of these embodiments the signal source is activated as a function of the information such that it outputs a signal, in particular defined by the activation, if the information results from an evaluation result, accordingly at least one seat of the seating arrangement is occupied and/or a selected specified seat occupancy state is present.

In some embodiments, the method further includes: (i) detecting a seatbelt fastening state of at least one seat in the seating arrangement or receiving seatbelt information identifying this seatbelt fastening state; (ii) wherein the signal source is activated as a function of the seatbelt information and the information from the evaluation result in such a way that it outputs a seatbelt fastening warning signal if, according to the information, at least one seat of the seating arrangement is occupied and/or a selected specified seat occupancy state is present and seatbelt information indicates that the associated seatbelt of the seat is not fastened. In this way, radar-based seatbelt checking and warning systems can be achieved, in particular with regard to the detection only.

In some embodiments, the individual radar points of the radar point cloud are represented by a position of the respective radar point in three-dimensional space and by at least one of the following parameters: (i) a Doppler-shift value of the radar signal at the relevant radar point; (iii) a signal-to-noise ratio value of the radar signal at the relevant radar point. These parameters can be used in particular for pre-filtering the radar point cloud as part of a pre-processing stage prior to the feature determination.

The fourth aspect of the present solution relates to a system, in particular a data processing system, for the automated detection of an in particular respective seat occupancy state of a seat arrangement having at least one seat, in particular having at least one vehicle seat in or for a vehicle. The system has a data processing device which is configured to carry out the method according to the third aspect to detect the seat occupancy state, in particular by means of a corresponding computer program.

A fifth aspect of the present solution relates to a computer program or computer program product, having instructions which, when they are executed on the data processing device of the system according to the fourth aspect, cause the system to carry out the method according to the third aspect.

The computer program can, in particular, be stored in a non-volatile data carrier. This is preferably a data carrier in the form of an optical data carrier or a flash memory module. This may be advantageous if the computer program as such is to be handled independently of a processor platform on which the one or more programs are to be run. In another implementation, the computer program can be present as a file on a data processing unit, in particular on a server, and can be downloaded via a data link, for example the Internet or a dedicated data link such as a proprietary or local network. In addition, the computer program can have a plurality of individual interacting program modules. In particular, the modules can be configured to be used, or in any case can be used, in such a way that they can be used in the sense of distributed computing on different devices (computers or processor units) that are geographically remote and connected to one another via a data network.

The system according to the fourth aspect can accordingly have a program memory in which a computer program is stored. Alternatively, the system can also be configured to access, via a communication link, a computer program which is available externally, for example on one or more servers or other data processing units, in particular in order to exchange therewith data which is used while the method or computer program is running, or constitutes outputs of the computer program.

A sixth aspect of the present solution relates to a vehicle, having (i) a seat arrangement having at least one seat, (ii) a radar sensor for radar scanning of at least sections of the seat arrangement, and (iii) a system according to the fourth aspect for the automated detection of any particular respective seat occupancy state of the seat arrangement as a function of radar scanning of at least sections of the seat arrangement, carried out by the radar sensor, in particular according to a method according to the third aspect.

The features and advantages explained in relation to one of the aspects of the present solution are correspondingly also true of the further aspects of the solution.

Further advantages, features and possible applications of the present solution can be gathered from the following more detailed description in conjunction with the drawings.

In the figures:

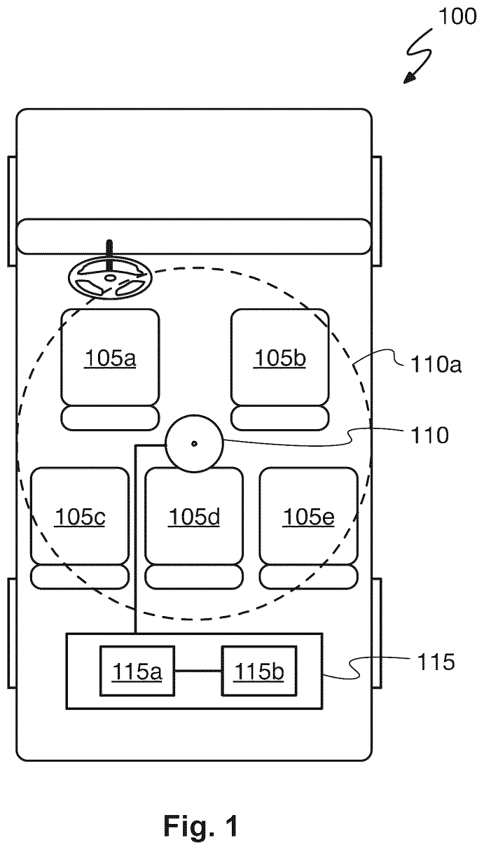

FIG. 1 shows schematically an exemplary embodiment of a vehicle, which is equipped with a system for the automated detection of a seat occupancy state of a seating arrangement in the vehicle;

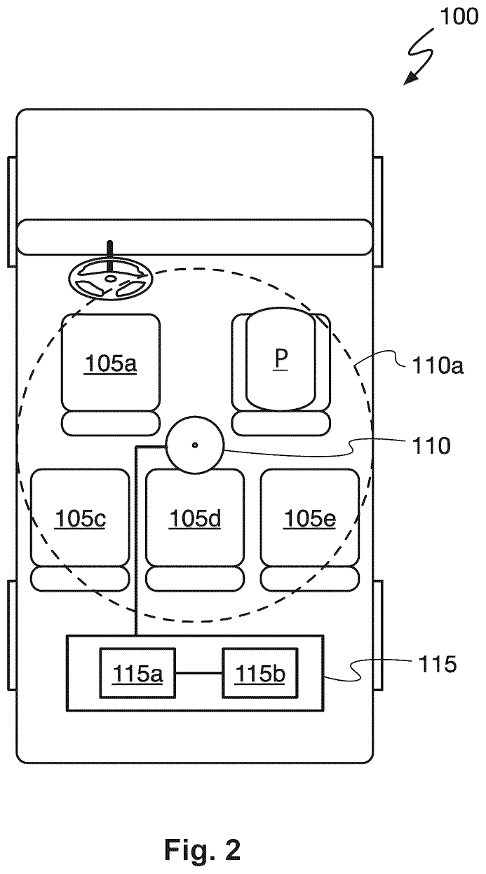

FIG. 2 shows schematically the vehicle from FIG. 1, wherein here the passenger's seat is occupied;

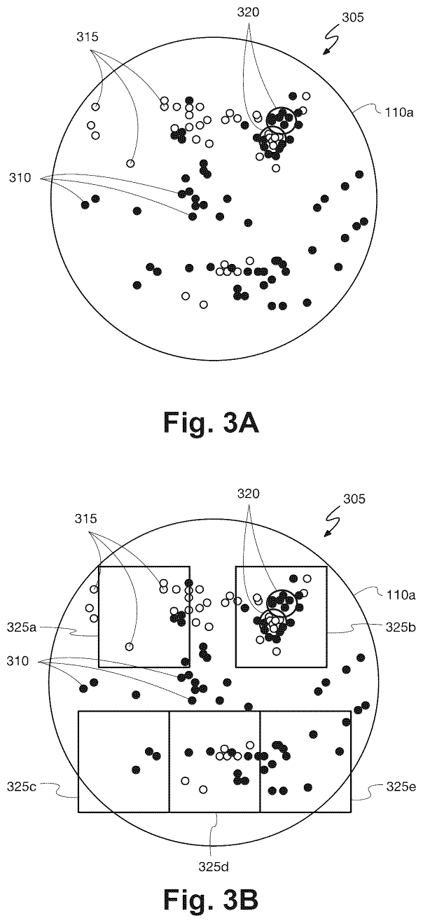

FIG. 3A shows an exemplary two-dimensional representation of a radar point cloud recorded by a radar sensor of the vehicle from FIG. 2;

FIG. 3B shows an exemplary representation of clustering of the radar point cloud from FIG. 3A according to the positions of the individual seats of the seat arrangement;

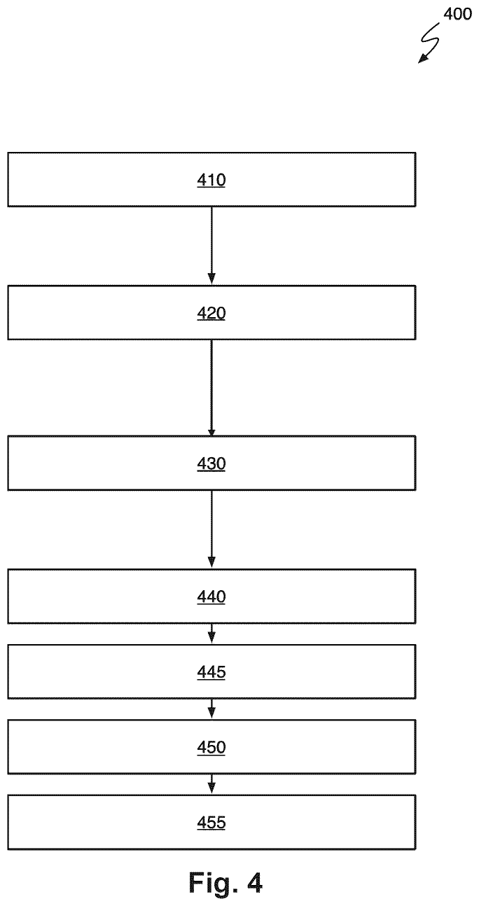

FIG. 4 shows a flowchart to illustrate an exemplary embodiment of a method for the automated detection seat occupancy state of a seat arrangement; and

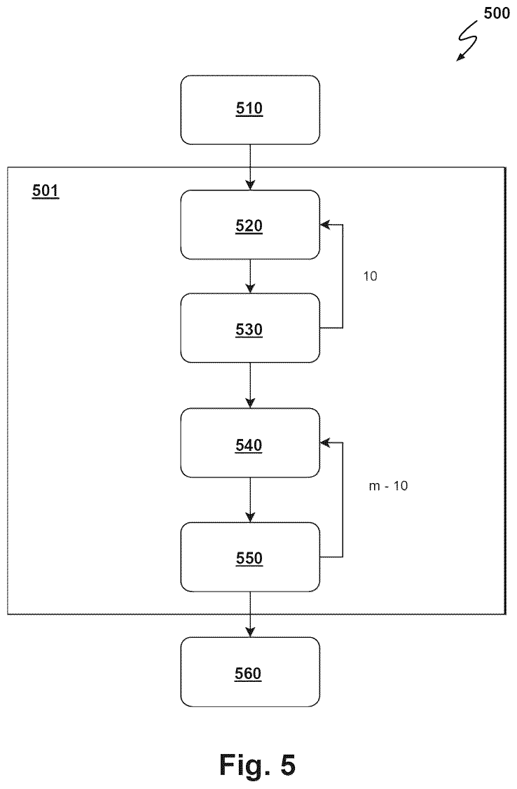

FIG. 5 shows a flowchart to illustrate an exemplary embodiment of a method for producing an evaluation model for the automated detection of a seat occupancy state of the seat arrangement.

In the figures, identical reference signs designate identical, similar, or mutually corresponding elements. Elements in the figures shown are not necessarily shown to scale. Rather, the different elements shown in the figures are reproduced in such a way that their function and general purpose are understandable to the person skilled in the art. Connections and couplings between functional units and elements shown in the figures can, unless explicitly stated otherwise, also be implemented as an indirect connection or coupling. Functional units can be implemented in particular as hardware, software, or a combination of hardware and software.

Firstly, with reference to FIGS. 1 to 4, the detection of a seat occupancy of a vehicle by means of a radar system will be described, since the method according to the present invention can advantageously be applied in this context. The present invention will then be explained in particular with reference to FIG. 5.

The exemplary embodiment of a vehicle 100 schematically illustrated in FIG. 1 has a seating arrangement 105 with five individual seats or seating positions 105a to 105e. Each of the seats 105a to 105e is suitable for accommodating one person as a passenger of the vehicle 100. The vehicle 100 further comprises a radar sensor 110, which is mounted inside the vehicle cabin on its ceiling and configured such that it can scan the seating arrangement 105, at least substantially, by means of radar beams. Accordingly, the seats 105a to 105e, in particular their seat surfaces, are located at least in each case predominantly within an observation field 110a that can be scanned by the radar sensor 110. In addition, the vehicle 100 comprises a system 115 for the automated detection of a seat occupancy state of the seating arrangement 105 as a function of a radar scan of at least sections of the seating arrangement 105 with respect to the observation field 110a, carried out by the radar sensor 110.

The system 115 comprises in particular a data processing unit 115a with at least one microprocessor and a memory 115b with a signal connection to it, in which a computer program is stored, which is configured for carrying out the method described below with reference to FIG. 4, for the automated detection of a seat occupancy state of the seating arrangement 105. Furthermore, the sensor data generated by the radar sensor 110 during the radar scanning or information already obtained from this by further processing can be or is stored in the memory 115b.

The vehicle 100 illustrated in FIG. 2 corresponds to the vehicle from FIG. 1 but here the passenger seat 105b is occupied by a person P. In the further following discussion of FIGS. 3A and 3B, reference is made to the constellation from FIG. 2.

Reference is now made below to FIGS. 3A and 3B, which each illustrate a radar point cloud wherein, for the purpose of representation, the respective, intrinsically three-dimensional radar point cloud has been reduced to two dimensions by projecting the positions of the radar points of the radar point cloud onto a plane spanned by two of its dimensions.

An exemplary radar point cloud 305 is illustrated in FIG. 3A, as was captured as a result of radar scanning of the seat arrangement 105 by the radar sensor 110 during a fixed time interval (measurement time period). The position of the individual radar points within the radar point cloud 305 can be represented by spatial coordinates, for example, Cartesian coordinates X and Y can be assigned to the plane of the drawing and thus to each individual point. In reality, if the dimension reduction due to the drawing is disregarded, a third coordinate Z should be added for the third spatial dimension.

If not only the spatial positions of the locations where the radar beam is reflected from the scanned objects are acquired as coordinates during the radar scanning, but a Doppler shift is measured as well, then the individual radar points can be classified according to the magnitude of this Doppler shift, in particular into two different classes. The latter can be achieved, for example, by comparing the Doppler shift with a specified shift threshold that corresponds to a certain shift velocity. Depending on the result of the comparison, those radar points 310 which, according to the value of their associated Doppler shift, have no speed or a speed of the object surface at the reflection point which lies below the shift threshold, are classified as “static” radar points (each illustrated in FIGS. 3A and 3B by a filled black circle). Conversely, those radar points 315 which have a Doppler shift above the shift threshold are classified as “dynamic” radar points 315 (each illustrated in FIGS. 3A and 3B by a black ring).

The classification of the radar points 310 and 315 according to their Doppler shift is not mandatory, but it can be used, however, to process the radar point cloud 305, in particular in the context of a pre-processing carried out before its evaluation, in particular to filter it depending on the classification. For example, this filtering could be carried out in such a way that only dynamic radar points 315 are taken into account for the evaluation, for example, in order to detect only moving objects.

FIG. 3B shows the same radar point cloud 305 as in FIG. 3A. In addition, however, cuboid (3D case) or in the present 2D representation, rectangular, selected spatial regions 325a to 325e are indicated here, which are spatially assigned to the respective position of the individual seats 105a to 105e. The definition of these spatial regions 325a to 325e can then be used to cluster the radar point cloud 305, wherein each radar point. 310 or 315 is as far as possible assigned to that spatial region 325a to 325e in which it is located. Any radar points not located in one of the spatial regions 325a to 325e may be subsequently disregarded. Alternatively or additionally, points located outside can also be assigned to the nearest spatial region, provided that these do not exceed a previously defined distance from the spatial region center point. It can be seen in particular that the regions 320 with a particularly high radar point density are located in the region of the passenger seat 105b, on which, according to FIG. 2, the person P is located.

FIG. 4 shows a flowchart to illustrate an exemplary embodiment 400 of a method for the automated detection of a seat occupancy state of a seat arrangement. The method can in particular be embodied as a computer-implemented method. For this purpose, it can be stored in particular in the memory 115b of the system 115 as a computer program and be executable on the data processing unit 115a.

In the method 400, a radar point cloud 305 is captured, in that, in a step 410, radar measured data, in the present example from the radar sensor 110 of the vehicle 100, are received and processed further to form one or more radar point clouds.

The radar point cloud 305 that is then present can then be clustered in a further process 420, in that a check is made for each of its radar points as to whether it is located within one of the defined spatial regions 325a to 325e (cf. FIG. 3B) and, if appropriate, in which. Thus, each one of all the points can be assigned either to one of the spatial regions 325a to 325e or to the other observation field. All radar points that are located within the same spatial region 325a to 325e are combined to form a cluster. As a result, each of the seats 105a to 105e is thus assigned a corresponding cluster from the radar point cloud 305. This forms the basis for the fact that, for each seat 105a to 105e, an evaluation can be carried out individually as to whether the respective seat 105a to 105e is or was or is not occupied while the radar point cloud 305 was being formed.

In order to facilitate the following evaluation of the clustered radar point cloud 305, for each of the clusters a corresponding characteristic variable K or a plurality of characteristic variables K with preferably different properties can be determined in a process 430, wherein this characteristic variable K can in particular be defined as the number of radar points in the cluster. If no Doppler-shift value filtering has taken place, this can be a combined count of both the static and the dynamic radar points 310 and 315, respectively. If, however, the static radar points 310 have previously been filtered, this is only a count of the dynamic radar points 315.

The evaluation of the characteristic variable K for the cluster relating to the seat 105b can then be carried out (the same can be done analogously for the respective clusters relating to the other seats). To this end, in the process 440, the characteristic variable K (or a variation over time of the characteristic variable K) can be made available to an evaluation model as an input variable. This can in particular be a model based on machine learning, such as an artificial neural network or a decision-tree-based model. The training and possibly validation data used for the preceding training can be structured in such a way that, in each case, depending on the type of characteristic variable K, for a multiplicity of different radar point clouds or clusters thereof and in each case a variation of K, it contains an associated correct class from a classification of possible seat occupancy states. This allows the model to be trained and validated as part of a supervised learning procedure. In the simplest case, seat occupancy states indicate whether the seat is occupied or not. However, further developed classifications are also conceivable in which, if an object is present, what type of object this is is specified by the respective class, for example a moving or a non-moving one and, in the case of a moving object, in particular whether this is a person (in principle, in particular by using a breathing pattern detectable in the course of the characteristic variable K).

If in the process 440 a seat occupancy state was determined on the basis of the evaluation model for the seating arrangement 105, in particular individually for one or more of its seats 105a to 105e, this result can be output as corresponding information in process 445, for example, on a user interface of the vehicle or in the form of data for further processing by one or more other systems, in particular systems of the vehicle.

In this example, this information will be used in particular to check whether or not a belt warning signal should be issued, depending on the seat occupancy state of a particular seat 105a to 105e and the result of a check to determine whether or not a corresponding seatbelt for that seat has been fastened.

To do this, in process 450 it can be checked whether the seatbelt for the seat concerned (here, for example, for seat 105b) is fastened and in step 455 a functionality of the vehicle 100 is controlled depending on the information output in process 445 relating to the seat occupancy state and the status of the seatbelt determined in process 450. In particular, this can be carried out in such a way that in process 455 a signal source for outputting an in particular optical and/or acoustic seatbelt status signal is activated in order to signal to one or more other occupants of the vehicle, if necessary, that a seat is occupied but the seatbelt there is not fastened. The method then branches back to step 410 to start another loop pass.

The evaluation model is produced before the actual application in the method 400 and before the training. In particular, appropriate optimization of the hyperparameters is carried out, as explained below. A flowchart to illustrate an exemplary embodiment of the method 500 for producing the evaluation model is illustrated in FIG. 5.

In a step 510, firstly a dataset having various seat occupancy states (parameters) is provided. This is processed in the evaluation model. In particular, this is used to optimize the hyperparameters before the evaluation model produced is finally trained with the training data (step 560). For the hyperparameter optimization, a metric is applied which is optimized with an optimization method 501 (here Bayesian optimization).

The dataset in particular contains different seat occupancy states comprising humans, objects and empty seats, in which a decision is to be made for each seat as to whether a seatbelt fastening reminder (i.e. a belt warning signal) must be output, as explained above. The decision in this regard is based on the presence of a human and their size (in the case of children, the age is used, since this is highly correlated with size). The dataset is very unbalanced in relation to age and/or size of the passengers. Therefore, the various types of passengers (or seat occupancy states) are weighted in order to achieve an optimal overall classification, without an under-represented group of passengers (e.g. AM95, AF05) having a poor detection accuracy (while the detection accuracy should be relatively good anyway in groups which frequently occur, e.g. Medium-sized adults (such as AM50)). These weights are optimized with the aid of the Bayesian optimization in order to obtain a more balanced overall result.

One important building block is the selection of the metric. The metric described below is therefore conceived in such a way that it punishes overconfidence, in that it defines an upper limit for the metric, i.e. a target value for the detection accuracy (or, for short: accuracy). Thus, the optimization of the metric is not aimed at reaching a 100% detection accuracy (value 1) but, for example, at 95% (value 0.95), in order to obtain the intended more balanced overall result. The target value is defined for the accuracy for each possible combination as described below.

Firstly, a series of parameters is selected, i.e. various seat occupancy states for which an equilibrium is to be produced, e.g. whether the engine is running or not or the seat occupancy of a specific seat 105a to 105e. One combination would be, for example: AF05 (small woman) on the driver's seat while the vehicle is stationary. This is a combination of the size (of the person), the seat and the state of the vehicle.

The accuracy is calculated for all possible combinations of the selected parameters. From each of these calculated accuracies, the magnitude of the difference between the defined target value and the calculated accuracy is calculated for each combination of parameters. These magnitudes are then used as exponents in the natural exponential function. In this way, classes which are further removed from the desired target are punished more highly than classes which are already close to it. The geometric mean of each of these values is then calculated. As a result, all values are ultimately maximized and not just one of them. Finally, the value obtained is also normalized, so that it lies in the range from 0 to 1. Smaller values are better, so that this can be used as a direct input to the Bayesian optimization, which then attempts to minimize this value.

The metric can accordingly be implemented in practical terms as the following function:

$$\\ raw = \sqrt[n]{{\prod }_{i = 0}^{n} {e}^{\vert {accuracy}_{i} - target \vert}} \\ normalized = \frac{raw - 1}{e - 1}$$

where n is the number of combinations of the selected parameters (e.g. n=3: child in a moving vehicle, no child in the moving auto, child in the stationary auto, no child in the stationary auto). The normalized value “normalized” accordingly assumes values between 0 and 1 (i.e. in the interval [0,1]). The detection accuracy (accuracy) is designated as “accuracy”, the target value as “target”.

For the Bayesian optimization 501, a fixed number of iterations (m) is defined before the start. The Bayesian optimization optimizes the above-described metric in order to adjust the hyper parameters (“hyperparameter optimization”). The Bayesian optimization 501 treats the aforementioned function, which defines the metric, as a random function which it attempts to estimate. The number of iterations is defined since this theoretically has no limit in the Bayesian optimization because of the implementation. The hyperparameters are provided, a range of input values being specified for each hyperparameter and the Bayesian optimization 501 selecting random values for the first pair of iterations (here: 10) (step 520). After the 10th iteration, wherein the evaluation model is in each case trained with the parameters from the dataset and the metric is evaluated (step 530), the Bayesian optimization 501 selects the most promising hyperparameters (step 540).

In the next (m−1) iterations, wherein the evaluation model is in each case further or newly trained with the parameters from the dataset and the metric is appropriately evaluated (step 550), the most promising hyperparameters are likewise always selected. In particular, the respectively next selected hyperparameters are those from the range of input values which offer the greatest potential for minimizing the metric. After the selected number of iterations has been run through (here, therefore, a total of m), the result of the process (i.e. of the Bayesian optimization 501) is that set of hyperparameters which has been evaluated and leads to the lowest measured value.

As already mentioned above, in step 560 the evaluation model is finally trained with the selected hyperparameters and stored. It transpires that a better balance for the various groups can be achieved in the evaluation result.

While at least one exemplary embodiment has been described above, it should be noted that there are a large number of variations in this respect. It is also to be noted here that the described exemplary embodiments constitute only non-limiting examples and it is not intended thereby to limit the scope, applicability or configuration of the devices and methods described here. Instead, the above description will provide a person skilled in the art with an indication for the implementation of at least one exemplary embodiment, wherein it is understood that various changes in the functioning and the arrangement of the elements described in an exemplary embodiment can be made without departing here from the subject matter which is respectively defined in the appended claims or its legal equivalents.

### LIST OF REFERENCE SIGNS

P Person on the driver's seat
100 Vehicle
105 Seat arrangement
105a-e Seats
110 Radar sensor
110a Observation field of the radar sensor 110
115 System for the automated detection of a seat occupancy state
115a Data processing unit
115b Memory
305 Radar point cloud
310 Static radar points
315 Dynamic radar points
320 Regions of the radar point cloud 305 with a high radar point density
325a-e Spatial regions for cluster definition
400 Method for the automatic detection of a seat occupancy state
410-455 Individual processes or method steps within the context of the method 400
500 Method for producing an evaluation model
501 Optimization method
510-560 Individual processes or method steps within the context of the method 500

1. A method for producing an evaluation model for automated detection of a seat occupancy state of a seat arrangement having at least one seat, wherein the method comprises:
providing parameters which are assigned to at least one of a plurality of specified possible seat occupancy states of the seat arrangement;
providing hyperparameters for the evaluation model, wherein the hyperparameters are configured to be adjusted on the basis of a metric;
determining a detection accuracy, wherein the detection accuracy indicates a discrepancy between the seat occupancy state assigned to the parameters and an evaluation result supplied by the evaluation model with the provided hyperparameters;
providing a metric and evaluating the metric, wherein the metric takes into account a difference between the detection accuracy and a specified target value in order to output a value for a determined detection accuracy, wherein the target value indicates a detection accuracy at which the metric reaches an optimum;
adjusting the hyperparameters, wherein the metric is optimized by means of an optimization method for this purpose; and
producing the evaluation model with the adjusted hyperparameters for training with training data for a method for the automated detection of a seat occupancy state of a seat arrangement having at least one seat.

2. The method as claimed in claim 1, wherein the target value is smaller than a maximum detection accuracy, so that the value of the metric is a maximum for the target value.

3. The method as claimed in claim 1, comprising providing a set of parameters which are assigned to a plurality of seat occupancy states, and the detection accuracy is in each case determined for combinations of parameters from the set of parameters, wherein the metric is defined as an average which is formed for the set of parameters and the respective detection accuracy.

4. The method as claimed in claim 1, wherein the metric includes the natural exponential function, which comprises a magnitude of a difference between the detection accuracy and the target value as an argument.

5. The method as claimed in claim 1, wherein the optimization method is a Bayesian optimization.

6. The method as claimed in claim 1, wherein the optimization method is carried out with a specified number of iterations.

7. The method as claimed in claim 1, wherein the seat arrangement has a plurality of seats, wherein the seat occupancy state is an individual or cumulative seat occupancy state of the seats.

8. The method as claimed in claim 1, wherein the seat occupancy state comprises at least one type of seat occupancy for at least one seat of the seat arrangement.

9. The method as claimed in claim 1, wherein the parameters further comprise a state of the vehicle.

10. A method for training an evaluation model produced in accordance with the method as claimed in claim 1 for the automated detection of a seat occupancy state of a seat arrangement having at least one seat, wherein the method comprises:
capturing measured data which represents an associated radar point cloud, wherein the radar point cloud is or has been obtained on the basis of radar scanning of at least sections of a spatial region encompassing the seat arrangement, and is assigned to one of a plurality of predefined possible seat occupancy states of the seat arrangement; and
producing training data from the measured data, wherein the training data is made available to the evaluation model as input data in order to obtain as its output an evaluation result which is assigned to the seat occupancy state of the seat arrangement.

11. A method for the automated detection of a seat occupancy state of a seating arrangement having at least one seat, wherein the method comprises:
capturing measurement data which represents an associated radar point cloud, wherein each radar point cloud is or has been obtained on the basis of radar scanning of at least sections of a spatial region encompassing the seat arrangement;
determining a seat occupancy state of the seat arrangement by using an evaluation model which has been trained in accordance with the method as claimed in claim 10 and, depending on the radar point cloud, supplies one or more predefined possible seat occupancy states of the seat arrangement as an evaluation result; and
issuing information defined as a function of the evaluation result.

12. The method as claimed in claim 11, wherein the issuing of the information comprises activating a signal source as a function of the information in order to cause the signal source to output a defined signal as a function of the activation, wherein the signal source is controlled in accordance with the information in such a way that it outputs a signal if the information results from an evaluation result according to which at least one seat of the seat arrangement is occupied and/or there is a selected predetermined seat occupancy state.

13. The method as claimed in claim 12, further comprising:
detecting a seatbelt fastening state of at least one seat in the seating arrangement or receiving seatbelt information characteristic of this seatbelt fastening state;
wherein the signal source is activated as a function of the seatbelt information and the information from the evaluation result, in such a way that it outputs a seatbelt fastening warning signal if, according to the information, at least one seat of the seating arrangement is occupied and/or a selected specified seat occupancy state is present and seatbelt information indicates that the associated seatbelt is not fastened.

14. A system for the automated detection of a seat occupancy state of a seat arrangement having at least one seat, wherein the system has a data processing device which is configured to carry out the method as claimed in claim 11 to detect the seat occupancy state.

15. A computer program or computer program product, comprising instructions which, when executed on a data processing device of a system cause the system to carry out the method as claimed in claim 11.

16. A vehicle, having:
a seating arrangement having at least one seat;
a radar sensor for radar scanning at least sections of the seating arrangement; and
a system as claimed in claim 14 for the automated detection of a seat occupancy state of the seating arrangement as a function of a radar scan of at least sections of the seating arrangement carried out by the radar sensor.
